(19) United States
(12) Patent Application Publication
(10) Pub. No.: US 2023/0097633 A1
(43) Pub. Date: Mar. 30, 2023

(54) HAIR CLIPPER HAVING A MAGNETIC DOOR

(71) Applicant: CONAIR LLC, STAMFORD, CT (US)

(72) Inventor: VITO CARLUCCI, STRATFORD, CT (US)

(73) Assignee: CONAIR LLC, STAMFORD, CT (US)

(21) Appl. No.: 17/487,571

(22) Filed: Sep. 28, 2021

(51) Int. Cl. B26B 19/04; B26B 19/38

(52) U.S. Cl. CPC B26B 19/046; B26B 19/3813; B26B 19/3846; B26B 19/3853; B26B 19/3873

(57) ABSTRACT

A hair cutting device includes a cutting head having a moveable trimmer blade and a stationary trimmer blade, a collection chamber beneath the moveable trimmer blade and the stationary trimmer blade for collecting hairs cut by the moveable trimmer blade and the stationary trimmer blade, and a cover enclosing the collection chamber, the cover being removably connected to the cutting head via a magnetic interface.

### FIELD OF THE INVENTION

The present invention relates generally to hair cutting devices and, more particularly, to a hair clipper having a magnetic door that is removable so as to allow for removal of hair clippings from a collection chamber.

### BACKGROUND OF THE INVENTION

A variety of hair cutting and shearing devices are known in the art. For example, conventional hair clippers typically include a handle and a cutter head attached to the handle. The cutter head has a stationary cutting blade and a movable (reciprocating or oscillating) cutting blade that are arranged in sliding, face-to-face contact with one another. In operation, the reciprocating blade is driven back and forth relative to the stationary blade as the trimmer is moved through the hair of a user or over the skin in an area to be trimmed, such that hair entering the teeth of the blades is trimmed. With most devices, the cut hairs simply fall to the floor or countertop.

Some existing hair clippers employ a collection chamber for collecting cut hairs, and a door enclosing the chamber which can be removed to allow for cleaning of the cut hairs from such chamber. Such existing collection chambers and doors, however, can be quite cumbersome to use. For example, properly locating and closing the door to enclose the collection chamber can be difficult and, even when properly aligned on the housing, the door may allow for the escape of cut hairs from the collection chamber due to a gaps or inadvertent movement of the door. In addition, existing mechanisms for retaining the door in the closed position can require much force and manipulation to open, which can result in quick, jarring movements that risk the cut hairs from the collection chamber spilling out onto the floor.

In view of the above, there is a need for an improved hair clipper having a collection chamber and removable door that obviates these known issues.

### SUMMARY OF THE INVENTION

It is an object of the present invention to provide a hair cutting device.

It is another object of the present invention to provide a hair cutting device having a cut hair collection chamber.

It is another object of the present invention to provide a hair cutting device having a removable door enclosing the collection chamber.

These and other objects are achieved by the present invention.

According to an embodiment of the present invention, a hair cutting device includes a cutting head having a moveable trimmer blade and a stationary trimmer blade, a collection chamber beneath the moveable trimmer blade and the stationary trimmer blade for collecting hairs cut by the moveable trimmer blade and the stationary trimmer blade, and a cover enclosing the collection chamber, the cover being removably connected to the cutting head via a magnetic interface.

According to another embodiment of the present invention, a method of operating a hair cutting device includes the steps of activating a motor of the hair cutting device to move a movable blade with respect to a stationary blade, placing the movable blade and the stationary blade into contact with hair of a user so as to cause the movable blade and the stationary blade to cut the hair, collecting hair clippings in a collection chamber located beneath the moveable blade and the stationary blade, and grasping a cover and exerting a pulling force on the cover member to overcome a magnetic attraction between the cover and a cutting head of the hair cutting device to remove the cover to provide access to the collection chamber.

According to yet another embodiment of the present invention, a hair cutting device includes a housing forming a handle, a cutting head connected to the housing, the cutting head having a moveable trimmer blade and a stationary trimmer blade, and a collection chamber beneath the moveable trimmer blade and the stationary trimmer blade for collecting hairs cut by the moveable trimmer blade and the stationary trimmer blade, and a door enclosing the collection chamber. The cutting head includes a first element formed from one of a magnetic material and a ferromagnetic material, and the door includes a second element formed from the other of the magnetic material and the ferromagnetic material. When the door is placed over the collection chamber the first element and the second element are magnetically attracted to one another to retain the door over the collection chamber.

### BRIEF DESCRIPTION OF THE DRAWINGS

The present invention will be better understood from reading the following description of non-limiting embodiments, with reference to the attached drawings, wherein below:

FIG. 1 is a perspective view of a hair cutting device according to an embodiment of the present invention.

FIG. 2 is another perspective view of the hair cutting device of FIG. 1.

FIG. 3 is a top plan view of the hair cutting device of FIG. 1.

FIG. 4 is a bottom plan view of the hair cutting device of FIG. 1.

FIG. 5 is a left side elevational view of the hair cutting device of FIG. 1.

FIG. 6 is a right side elevational view of the hair cutting device of FIG. 1.

FIG. 7 is a front elevational view of the hair cutting device of FIG. 1.

FIG. 8 is a rear elevational view of the hair cutting device of FIG. 1.

FIG. 9 is another perspective view of the hair cutting device of FIG. 1, showing a magnetic door of a collection chamber removed from the housing.

### DETAILED DESCRIPTION OF THE PREFERRED EMBODIMENT

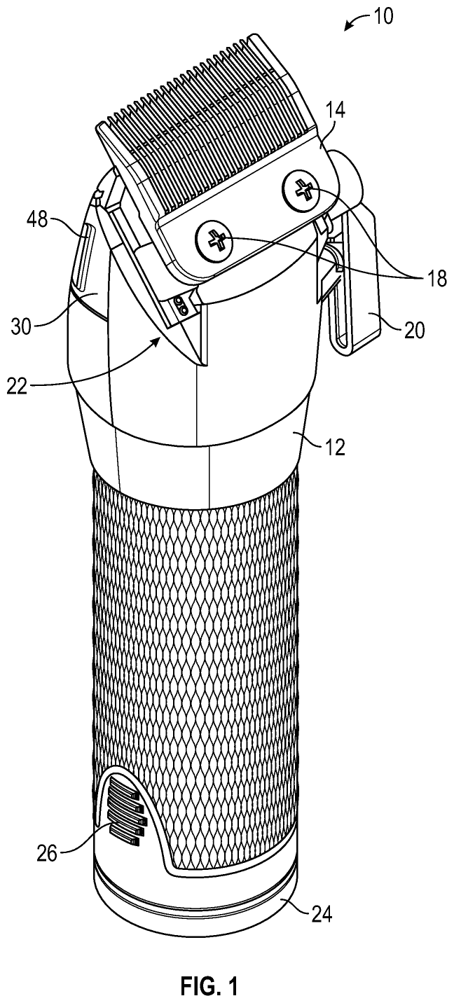

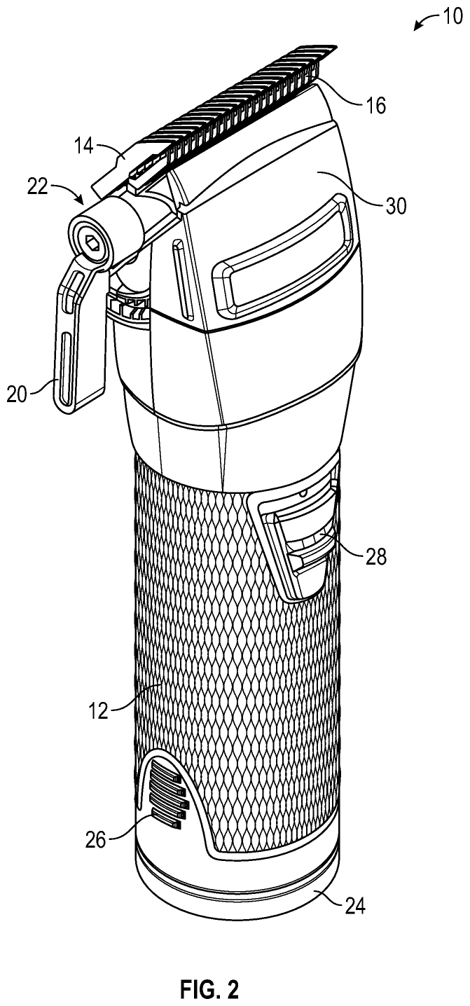

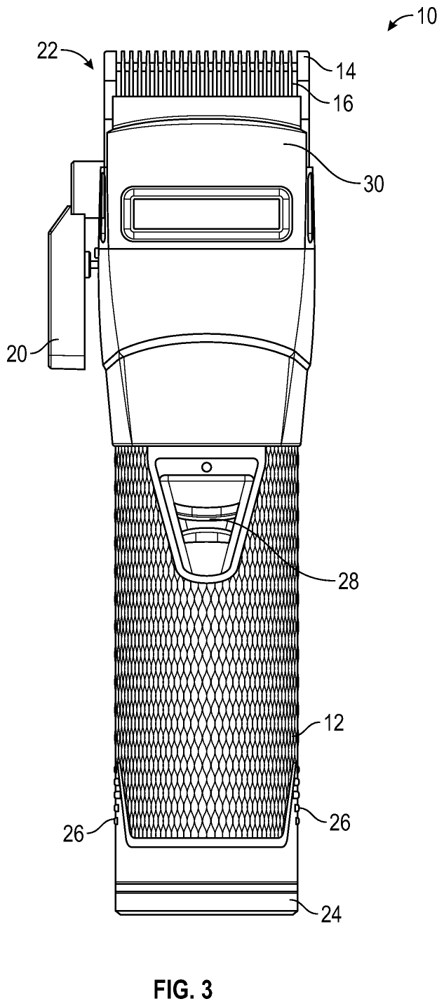

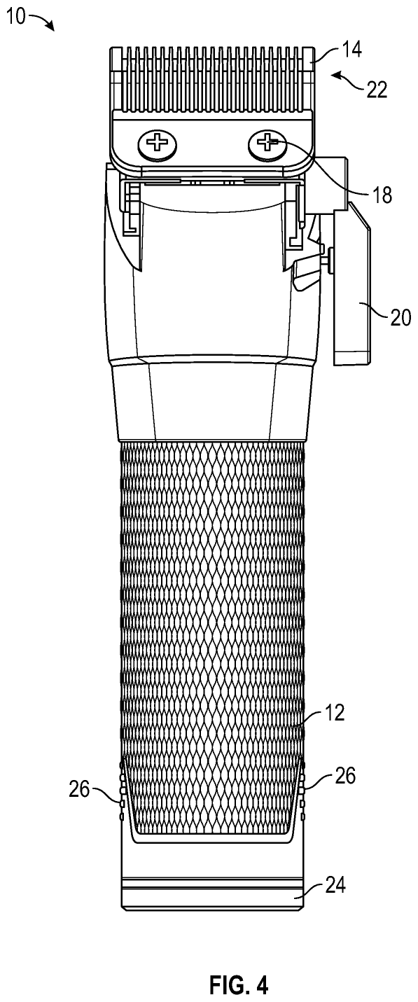

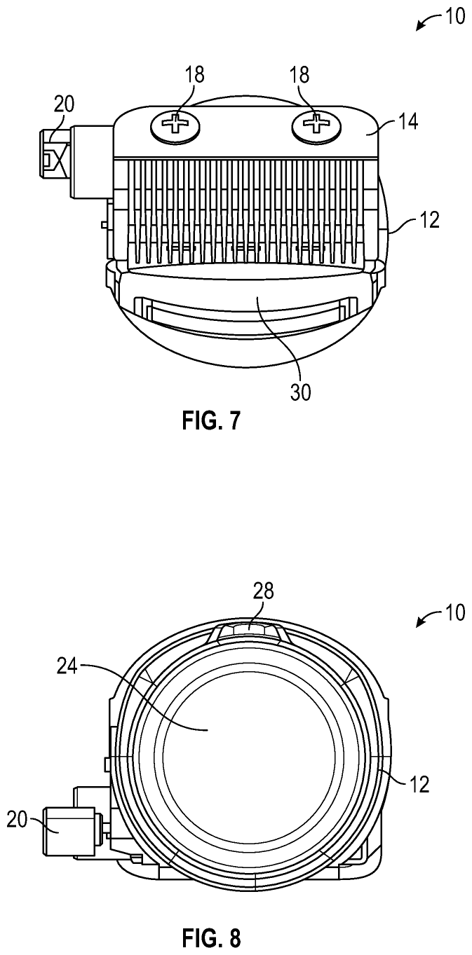

With reference to FIGS. 1-9, a hair cutting device 10 (also referred to herein as hair clipper 10) according to an embodiment of the present invention is illustrated. The term “clipper” is used throughout this specification to mean a hair cutting implement that includes two blades, at least one of the blades being reciprocated with respect to the other blade under the influence of a prime mover. The term “clipper” includes trimmers and any other devices that meet the foregoing general definition. The hair clipper 10 includes a housing 12 defining a handle portion, and a cutting head 22 having a stationary blade 14 and a moving blade 16. The blades 14, 16 have complimentary teeth separated by spaces. As is known in the art, the housing contains a motor (not shown) that is operatively connected to the moving blade 16 via a blade drive assembly 34.

In operation, the motor, via the blade drive assembly, reciprocates the moving blade 16 across the spaces to cut hair that enters the spaces. The stationary blade 14 is secured to the housing 12, typically with screws 18. A blade height adjustment lever, or taper lever 20, is provided to adjust the height of the moving blade 16 with respect to the stationary blade 14.

In an embodiment, the motor is powered by a battery assembly 24 that is removably received within a recess in the underside of the housing 12. The battery assembly 24 includes a pair of resilient arm members 26 that, when depressed, enable the battery assembly 24 to be removed from the housing 12. When not depressed, the resilient arm members 26 retain the battery assembly 24 within the housing 12. While FIGS. 1-9 illustrate the use of a battery (e.g., a rechargeable battery) to power the motor, the present invention is not so limited in this regard. For example, it is contemplated the hair clipper 10 may be powered via a power cord electrically connected to a household power outlet. The housing 12 also includes a sliding switch 28 that is operable to active or deactivate the motor and thus the moving blade 16.

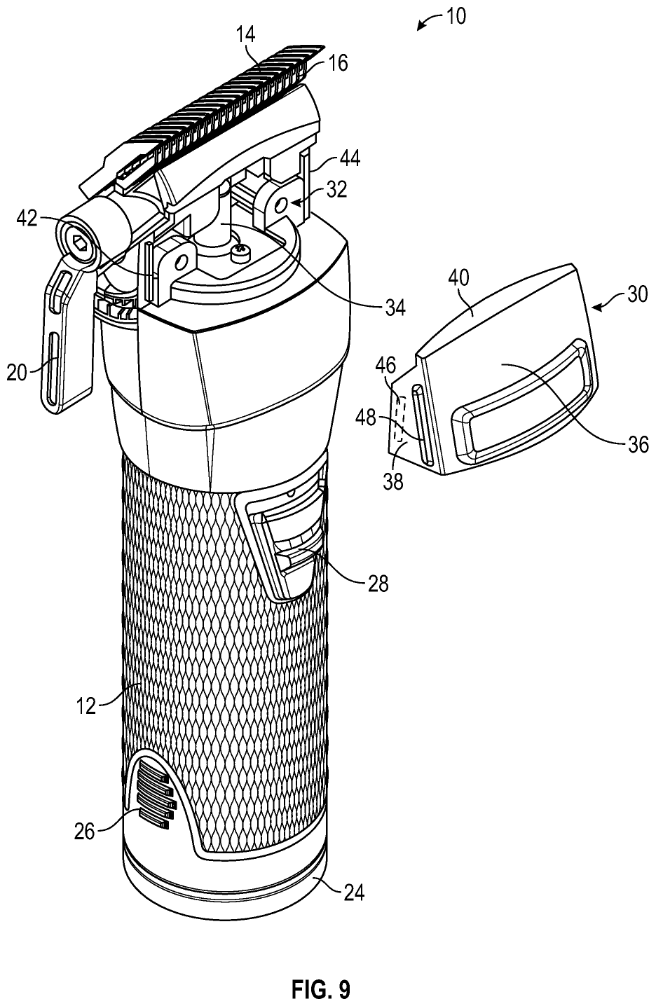

With specific reference to FIG. 9, the hair clipper 10 also includes a removable cover or door 30 that encloses a hair collection chamber 32 that is located generally beneath the blades 14, 16 within the cutting head 22, and which is in communication with the blades 14, 16 so as to receive hair clippings or trimmings therefrom. As shown therein, the cover 30 is removable from the cutting head 22 and housing 12 to allow access to the hair collection chamber 32 and the blade drive assembly 34 for the purposes discussed hereinafter.

As best shown in FIG. 9, the cover 30 includes a front panel member 36, opposed side panel members 38 that extend generally perpendicularly from the front panel member 36, and a narrow top panel member 40 that likewise extends generally perpendicularly from the front panel member 40. The front, side and top panel members 36, 38, 40 are contoured and shaped so that the cover 30 blends smoothly with the outer surfaces of the housing 12 and cutting head 22, as illustrated in FIGS. 1-6 and 9. In an embodiment, the top panel member 40 may be omitted so as to form a slot to provide a larger opening for hair clippings to pass from the blades 14, 16 into the collection chamber 32.

Importantly, the cutting head 22 includes a plurality of first interfacing elements 42, 44 formed as either magnets or from (or include) a ferromagnetic material that are configured to interface with second interfacing elements 46 of the other of magnets or a ferromagnetic material located on the inside surfaces of the side panel members 38. In an embodiment, the elements 42, 44 on the cutting head 22 are formed as magnets, while the elements 46 on the opposed side panel members 46 are formed from a ferromagnetic material. Alternatively, it is contemplated that the elements 42, 44 on the cutting head 22 are formed as magnets, while the side panel members 38 of the cover 30 are, themselves, formed from a ferromagnetic material.

Moreover, while the magnets 42, 44 (or ferromagnetic elements) are depicted as being located on opposed sides of the cutting head 22 for magnetically interfacing with corresponding elements 46 on the side panel members 38 of the cover 30, it is contemplated that the interfacing elements may be located elsewhere on the cutting head 22 and cover 20. For example, the magnetically interfacing elements on the cover 20 may be located along the side panel members 38, top panel member 40 and/or the lower edge of the front panel member 36 (for magnetically interfacing within correspondingly located magnetic or ferromagnetic elements, as the case may be, on the cutting head 22).

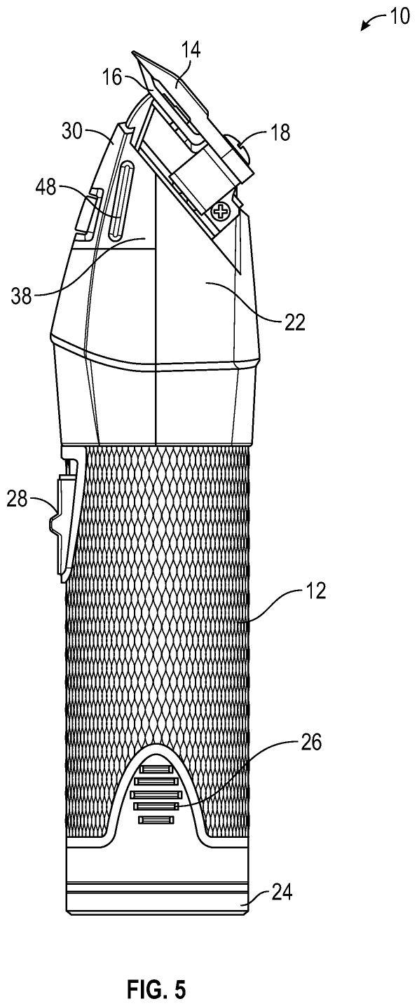

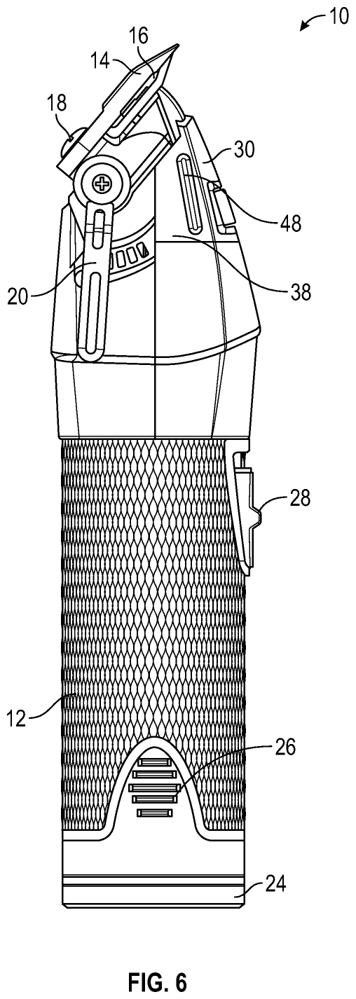

As also shown in FIGS. 5 and 6, in an embodiment, the side panel members 38 of the cover 30 include gripping elements 48. In an embodiment, the gripping elements 48 are formed as raised ridges. In other embodiments, the gripping elements 38 may be formed as a depression.

In use, the interfacing elements on the cover 30 and cutting head 22 magnetically retain the cover 30 in position on the cutting head 22 to enclose the collection chamber 32. The cover 30 can be easily removed by grasping the opposed side members 38, via the gripping elements 48, and pulling the cover 30 from the cutting head to overcome the magnetic attraction between such components. Importantly, the configuration of the cover and the use of a magnetic coupling to retain the cover 30 in position also serves to properly position and locate the cover 30 on the cutting head 22. In particular, even if the cover 30 is slightly misaligned with the cutting head 22 when installing the cover 30 over the collection chamber 32, the configuration of the cover 30 and the magnetic attraction between the cover 30 and the cutting head 22 functions to automatically move the cover 30 to its properly seated position on the cutting head 22. This is in contrast to existing devices where proper installation of the cover relies on precise positioning by a user, and where misalignment must be corrected by a user.

As alluded to above, the cover 30 of the clipper 10 is selectively removable from the cutting head to afford access to the hair collection chamber 32 and the blade drive assembly 34, without the use of tools, so as to facilitate lubrication, cleaning, or replacement of the blade drive assembly 15, as may be desired, as well as for cleaning of the chamber 32 of hair clippings from the collection chamber 32.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A hair cutting device, comprising:
a cutting head having a moveable trimmer blade and a stationary trimmer blade;
a collection chamber beneath the moveable trimmer blade and the stationary trimmer blade for collecting hairs cut by the moveable trimmer blade and the stationary trimmer blade; and
a cover enclosing the collection chamber, the cover being removably connected to the cutting head via a magnetic interface.

2. The hair cutting device of claim 1, wherein:
the cover includes a front panel member and a pair of opposed side panel members extending from the front panel member.

3. The hair cutting device of claim 2, wherein:
the opposed side panel members each include a gripping element.

4. The hair cutting device of claim 3, wherein:
the gripping element is a raised ridge.

5. The hair cutting device of claim 1, wherein:
the magnetic interface includes at least one magnet on one of the cutting head and the cover and a ferromagnetic element on the other of the cutting head and the cover.

6. The hair cutting device of claim 1, wherein:
at least a portion of the cover is formed from a ferromagnetic material;
wherein the cutting head includes at least one magnet; and
wherein the magnetic interface is formed by the at least one magnet and the cover.

7. The hair cutting device of claim 2, wherein:
the magnetic interface includes a pair of magnets located on opposed sides of the cutting head, and a pair of ferromagnetic elements located on an inside surface of the opposed side panel members of the cover.

8. The hair cutting device of claim 2, wherein:
the magnetic interface includes a pair of magnets located inside surfaces of the opposed side panel members of the cover, and a pair of ferromagnetic elements located on opposing sides of the cutting head.

9. The hair cutting device of claim 1, further comprising:
a blade drive assembly operatively connected to the moveable trimmer blade and being configured to transmit a rotational output of a motor housed within the a housing of the hair cutting device into reciprocating movement of the moveable trimmer blade;
wherein the blade drive assembly is accessible via the collection chamber.

10. The hair cutting device of claim 1, further comprising:
a housing connected to the cutting head; and
a battery assembly having a battery removably receivable in the housing, the battery being configured to supply electrical power to a motor within the housing.

11. The hair cutting device of claim 10, wherein:
the battery assembly includes a pair of resilient arm members configured to releasably retain the battery within the housing.

12. The hair cutting device of claim 1, wherein:
the magnetic interface and cover are configured such that magnetic attraction between the cover member and the cutting head causes the cover to move to a seated position on the cutting head even when a degree of misalignment between the cover and the cutting head is present.

13. A method of operating a hair cutting device, comprising the steps of:
activating a motor of the hair cutting device to move a movable blade with respect to a stationary blade;
placing the movable blade and the stationary blade into contact with hair of a user so as to cause the movable blade and the stationary blade to cut the hair;
collecting hair clippings in a collection chamber located beneath the moveable blade and the stationary blade; and
grasping a cover and exerting a pulling force on the cover member to overcome a magnetic attraction between the cover and a cutting head of the hair cutting device to remove the cover to provide access to the collection chamber.

14. The method according to claim 13, further comprising the step of:
placing the cover over the collection chamber such that there exists a degree of misalignment between the cover and the collection chamber, wherein a configuration of the cover and a magnetic interface between the cover and the cutting head facilitates automatic movement, via magnetic attraction, of the cover member from a misaligned position to an aligned and seated position of the cover over the collection chamber.

15. The method according to claim 12, wherein:
the cover includes a front panel member and a pair of opposed side panel members;
wherein the opposed side panel members each include an element formed from one of a magnetic material and a ferromagnetic material; and
wherein the cutting head includes a pair of opposed elements formed from the other of the magnetic material and the ferromagnetic material.

16. A hair cutting device, comprising:
a housing forming a handle;
a cutting head connected to the housing, the cutting head having a moveable trimmer blade and a stationary trimmer blade, and a collection chamber beneath the moveable trimmer blade and the stationary trimmer blade for collecting hairs cut by the moveable trimmer blade and the stationary trimmer blade; and
a door enclosing the collection chamber;
wherein the cutting head includes a first element formed from one of a magnetic material and a ferromagnetic material;
wherein the door includes a second element formed from the other of the magnetic material and the ferromagnetic material; and
wherein when the door is placed over the collection chamber the first element and the second element are magnetically attracted to one another to retain the door over the collection chamber.

17. The hair cutting device of claim 16, wherein:
the first element on the cutting head is the magnetic material; and
wherein the door, itself, is magnetically attracted to the first element.

18. The hair cutting device of claim 16, wherein:
magnetic attraction between the first element and the second element causes the door to move to a seated position on the cutting head even when a degree of misalignment between the door and the cutting head is present.

19. The hair cutting device of claim 16, wherein:
the door includes a front panel member and a pair of opposed side panel members extending from the front panel member.

20. The hair cutting device of claim 19, wherein:
the opposed side panel members each include a raised gripping element.
